(19) United States
(12) Patent Application Publication
(10) Pub. No.: US 2024/0317349 A1
(43) Pub. Date: Sep. 26, 2024

(54) ATTACHMENT OF AN ENERGY STORE TO A VEHICLE FRAME BY MEANS OF A LEVER

(71) Applicant: ZF Friedrichshafen AG, Friedrichshafen (DE)

(72) Inventor: Finn Neumann, Blaustein (DE)

(21) Appl. No.: 18/579,029

(22) PCT Filed: Jul. 12, 2022
(86) PCT No.: PCT/EP2022/069482

§ 371 Date: Jan. 12, 2024

(30) Foreign Application Priority Data
Jul. 14, 2021 (DE) 10 2021 207 470.7

(51) Int. Cl. B62J 43/20; H01M 50/249; H01M 50/262

(52) U.S. Cl. CPC B62J 43/20; H01M 50/249; H01M 50/262; H01M 2220/20

(57) ABSTRACT

An arrangement for fixing an energy storage device on a vehicle frame includes a base module and a lever pivotably mounted to the base module. The lever is pivotable relative to the base module into an engagement position, and further pivotable from the engagement position into an end position. The lever is configured to engage an energy storage device when brought into the engagement position. Additionally, the lever forms part of a cam mechanism such that pivoting of the lever from the engagement position towards the end position is configured to cause displacement of an energy storage device towards the base module.

### CROSS-REFERENCE TO RELATED APPLICATION

The present application is related and has right of priority to German Patent Application No. 10 2021 207 470.7 filed on Jul. 14, 2021 and is a nationalization of PCT/EP2022/069482 filed in the European Patent Office on Jul. 12, 2022, both of which are incorporated by reference in their entirety for all purposes.

### FIELD OF THE INVENTION

The invention relates generally to an arrangement for fixing an energy store or “energy storage device” to a vehicle frame and to an energy storage device.

### BACKGROUND

Document DE 10 2019 204572 B3 discloses a lever mechanism for fixing a rechargeable battery in a bicycle frame. A lever engages into a recess in the rechargeable battery and braces the rechargeable battery in an axial direction away from the lever mechanism toward an opposite end face of the rechargeable battery. The rechargeable battery is electrically contacted on the opposite end face. The lever mechanism and the electrical contacting of the rechargeable battery must therefore be structurally separated from one another.

### SUMMARY OF THE INVENTION

The problem addressed by the invention is that of improving the fixing or attachment of an energy storage device relative to a vehicle frame.

The arrangement according to the invention is used for fixing an energy storage device on a vehicle frame. A vehicle frame is, in particular, a bicycle frame. The energy storage device is preferably an electric energy store or a rechargeable battery.

The arrangement includes a base module. A module refers to an arrangement of parts which are connected to form a structural unit. This is, therefore, an arrangement of parts, each of which is joined to one or multiple parts of the module. A module is characterized in that it is preassembled. The base module is installable into the vehicle frame as a preassembled unit.

The arrangement also includes a lever. The lever is pivotably mounted on the base module. The base module therefore forms a bearing point for the lever. The lever is pivotably fixed in a bearing at the bearing point.

Pivotability refers to an ability to be turned by an angle which is less than 360°. In particular, the angle is less than 270°, less than 180° or less than 90°. Preferably, the pivoting takes place about precisely one axis. This means that the lever cannot pivot or rotate about axes which are orthogonal thereto.

Pivoting enables the lever to be brought into engagement with the energy storage device. As a result, the lever in combination with the energy storage device forms a cam mechanism.

A cam mechanism refers to mechanisms, the output motion of which arises due to a constant following of a cam, which is rotatably mounted or guided in a straight line, by a follower which is rotatably mounted or guided in a straight line.

In the present case, the lever forms a rotatably mounted cam. A follower which is guided in a straight line is formed by the energy storage device. The cam mechanism converts a further pivoting of the lever into a displacement of the energy storage device. A further pivoting of the lever refers to a pivoting of the lever from a position of the lever, in which the lever engages with the energy storage device. The lever is therefore pivoted out of a start position, such that the lever engages with the energy storage device and pivots further without changing the direction of rotation. The resultant displacement of the energy storage device takes place relative to the base module. The energy storage device is therefore displaced from a start position into an end position relative to the base module. A distance between the energy storage device and the base module decreases during the displacement. When the energy storage device is located in the end position, the distance is therefore smaller in comparison to the start position. A measure of the distance is preferably a distance between an arbitrarily selectable reference point of the energy storage device and an arbitrarily selectable reference point of the base module. Preferably, both reference points lie on a straight line which extends parallel to the direction of the displacement.

The invention is advantageous, since it allows functionalities related to the energy storage device to be integrated in the base module. For instance, according to one preferred development, it is possible to integrate one or more electrical contacts for contacting the energy storage device into the base module. The contacts are used to establish electrically conductive connections with corresponding contacts of the energy storage device when the energy storage device is located in the end position. It is also possible to alternately fix energy storage devices having different axial lengths using the same arrangement.

According to one preferred development, the displacement of the energy storage device causes an electrical contact of the energy storage device and an electrical contact of the base module to come into contact with one another.

Moreover, the base module includes one or more electrical contacts for establishing electrical connections with the vehicle. These are integrated, for example, in one or more plug connectors, each of which is connected to a corresponding counterpiece of the vehicle when the base module is installed into the vehicle.

Preferably, the base module is further developed with one or more spring-loaded pins. The spring-loaded pins are tensioned against the energy storage device due to the displacement of the energy storage device from the start position into the end position. A spring force applied by the pins therefore counteracts the displacement of the energy storage device. This is usable to at least partially compensate for the weight force of the energy storage device during a horizontally inclined mounting of the energy storage device. Preferably, the energy storage device has one or more recesses into each of which a pin of the base module engages. In this way, the energy storage device is guided by the spring-loaded pins during the displacement.

In order to hold the energy storage device in the vehicle frame, in one preferred development, one or more holding elements or “holders” are provided, which form-lockingly engage with the energy storage device due to the displacement or are form-lockingly engaged with the energy storage device during the displacement. Preferably, the holding elements are not engaged with the energy storage device in the start position. The start position then corresponds to a position in which the energy storage device is insertable into the vehicle frame and removed from the vehicle frame. In this case, the holding elements engage with the energy storage device only as a result of the displacement. In particular, the holding elements are engaged when the energy storage device has reached the end position.

The holding elements are preferably further developed such that the holding elements in combination with the base module form a structural unit. This is achievable, for example, by a connecting bar which is joined with the holding elements on one side and with the base module on the other side. Assembly is simplified due to the development, since the holding elements are preassembled together with the base module. It is also possible to optimize the tolerances within the base module with respect to the battery regardless of the tolerances of the vehicle frame.

The direction of the above-described displacement of the energy storage device and a longitudinal axis of a tube of the vehicle frame are aligned parallel to one another in one preferred development. The tube of the vehicle frame is, in particular, a tube on which the energy storage device is fixed by the arrangement.

An axis about which the lever pivots and the direction of the displacement are aligned orthogonally to one another in another preferred development.

In one preferred development, the lever forms a guide surface. The lever therefore forms the cam of the aforementioned cam mechanism. The energy storage device is the follower in the form of a mating surface. When the lever is brought into engagement with the energy storage device, the guide surface comes to rest against the mating surface, according to the development. This means, the guide surface contacts the mating surface. If the lever is pivoted further, the guide surface slides down along the mating surface. This results in the above-described displacement of the energy storage device.

In another preferred development, the guide surface is arranged such that it intersects a plane in different axial positions depending on a pivot angle of the lever, the plane being aligned parallel to the direction of the displacement and extending through the mating surface, i.e., intersecting the mating surface. An axial position refers to a position in the direction of the displacement. The axial position which, according to the development, varies depending on the pivot angle, results in the above-described displacement of the energy storage device.

The guide surface results, for example, when the guide surface has a helical profile. In particular, at least a portion of the lever, which forms the guide surface, is modified so as to be helical.

The lever is preferably further developed so as to be two-piece, having a first part and a second part. The lever is pivotably mounted on the base module by the first part. This means, the first part is pivotably mounted on the base module. In addition, the above-described pivoting of the lever is equivalent to a pivoting of the first part. The second part is pivotably mounted on the first part. A pivot axis about which the second part is pivotable relative to the first part preferably extends parallel to a pivot axis about which the first part is pivotable relative to the base module.

The second part is brought into engagement with the energy storage device by pivoting the first part in the base module. The second part in combination with the energy storage device forms the above-described cam mechanism, such that a further pivoting of the first part is converted into the aforementioned displacement of the energy storage device. The pivotability of the second part allows for compensation for tolerance-related dimensional deviations within the arrangement.

Moreover, the lever is preferably further developed with a spring element. The spring element is operatively connected to or between the first part and to the second part. A spring force applied by the spring element therefore acts between the first part and the second part. The spring force brings about a torque which acts between the first part and the second part and guides a pivoting of the second part with respect to the first part or counteracts such a pivoting.

According to the development, the spring element braces the second part against the energy storage device during the further pivoting of the lever, i.e., during the further pivoting of the first part. Specifically, as the pivoting continues, a tolerance-related pivoting of the second part with respect to the first part takes place, which brings about a tensioning of the spring element between the first part and the second part. This results in a fixed, rattle-free fixation of the energy storage device.

Preferably, the arrangement is also further developed with a fixing mechanism, for example, a lock, with which the first part is fixable in a position which the first part assumes when the second part is braced against the energy storage device. Due to the fixation of the first part by the fixing mechanism, the above-described bracing of the second part against the energy storage device is maintained. A lock as the fixing mechanism simultaneously functions as theft protection.

Preferably, the lever is further developed to engage into a recess in the energy storage device by the above-described pivoting. The recess or a portion of the recess forms the follower of the above-described cam mechanism. Preferably, at least a portion of the recess is located in a lateral surface of the energy storage device.

The above-described energy storage device is an energy storage device according to the invention. This energy storage device is preferably further developed with a plate which is mounted on an end face of the energy storage device and covers a portion of the above-described recess. Preferably, this plate is further developed so as to form the above-described mating surface for the guide surface of the lever.

### BRIEF DESCRIPTION OF THE DRAWINGS

Preferred exemplary embodiments of the invention are represented in the figures, wherein:

FIG. 1 shows a fixing device relative to energy storage devices having different axial lengths;

FIGS. 2a through 2d show different orientations of a base module of the fixing device of FIG. 1 relative to an energy storage device, the base module having a lever;

FIG. 3 shows a detail view of the lever of the base module shown in FIGS. 2a through 2d; and

FIG. 4 shows a rechargeable-battery interface between a fixing device and an energy storage device.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

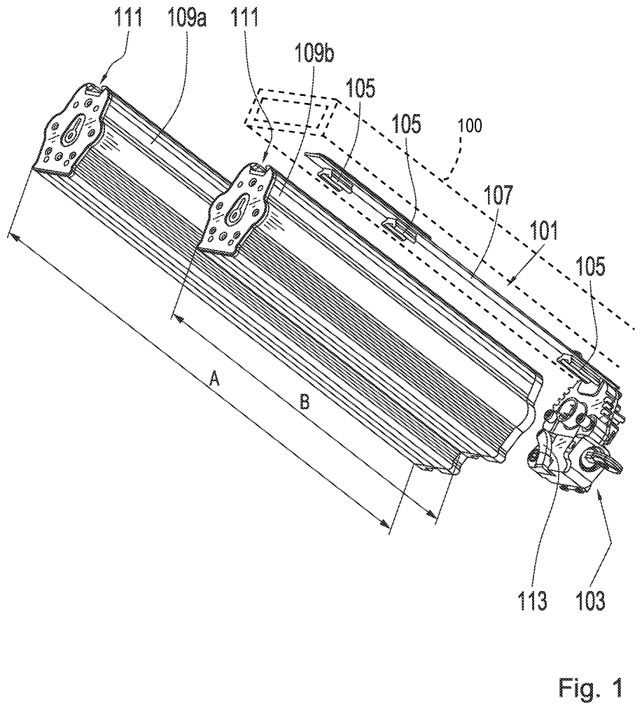

A fixing device 101 shown in FIG. 1 includes a base module 103, holding elements 105 or “holders,” and a bar 107. The base module 103 and the holding elements 105 are fixed on the bar 107. The bar 107 is screwable onto a bicycle frame 100 (e.g., a tube of bicycle frame 100).

The fixing device 101 is used to accommodate electric rechargeable batteries 109, such as a first electric rechargeable battery 109a and a second electric rechargeable battery 109b. The rechargeable batteries 109a, 109b each have a guide groove 111 with which the rechargeable batteries 109a, 109b are slidable onto the holding elements 105. The holding elements 105 form-lockingly engage into the guide groove 111.

Due to the design of the fixing device 101, it is possible to use rechargeable batteries 109a, 109b having different axial lengths. The first electric rechargeable battery 109a has an axial length A and the second electric rechargeable battery 109b has an axial length B. In some instances, the axial length A is greater than the axial length B.

A lever 113 is pivotably mounted to the base module 103. The lever 113 is usable to fix the rechargeable batteries 109a, 109b relative to the base module 103. The lever 113 is shown in a closed or end position in FIG. 1.

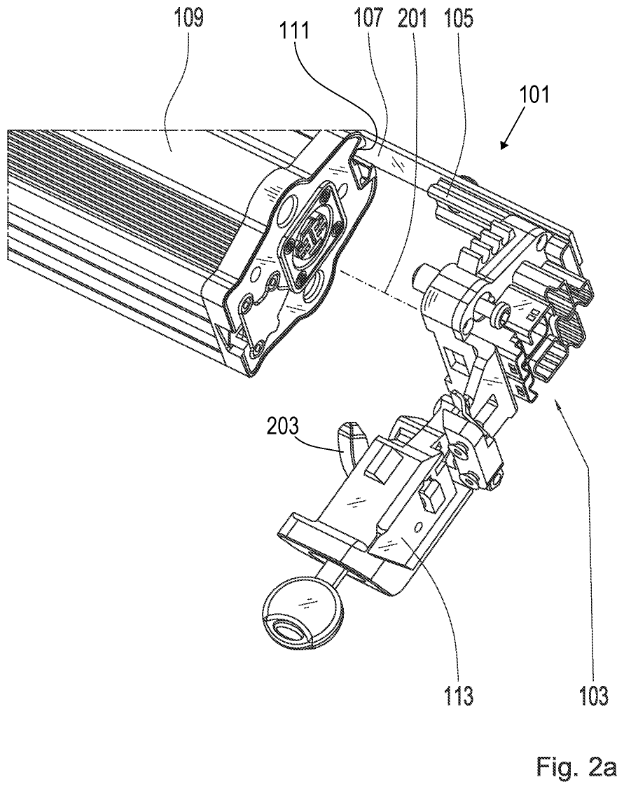

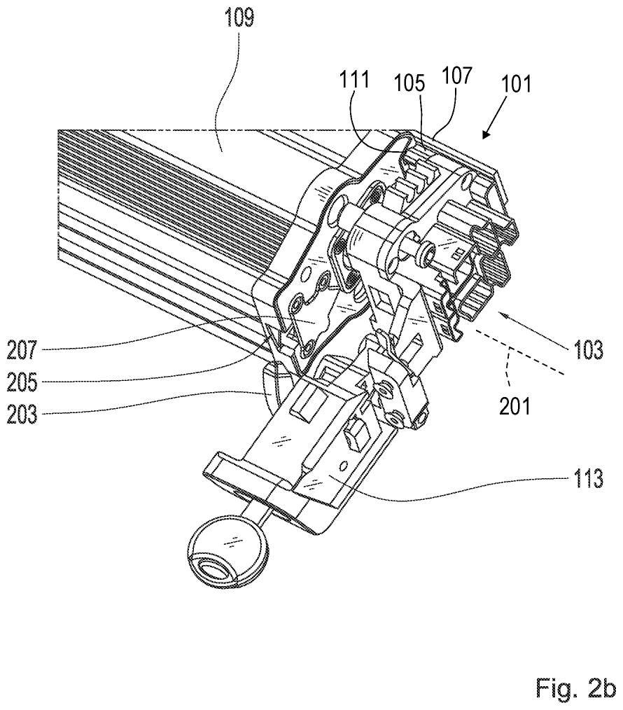

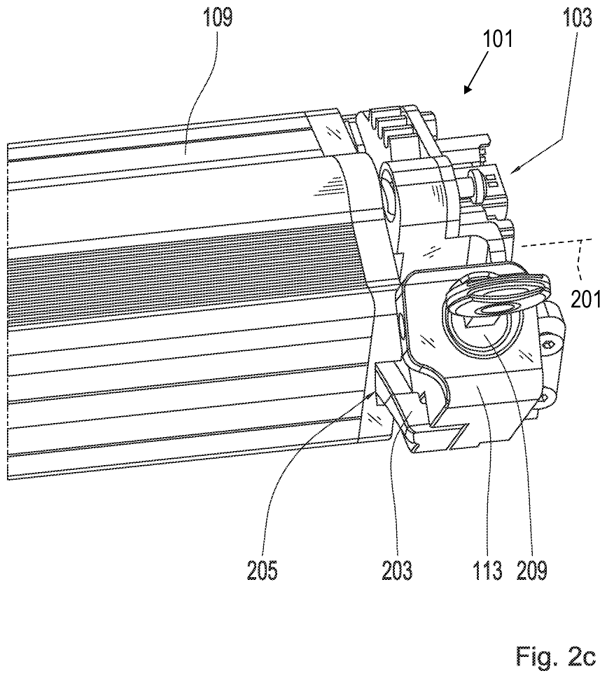

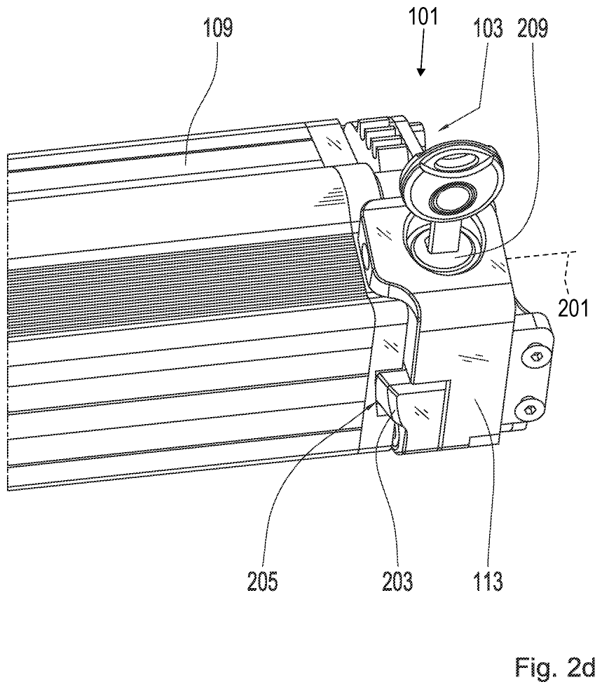

FIGS. 2a through 2d illustrate the function of the lever 113. For instance, FIGS. 2a through 2d show how a rechargeable battery 109 is inserted into the fixing device 101 and fixed relative to the fixing device 101 by the lever 113. As described above and illustrated in FIG. 2a, the rechargeable battery 109 is initially inserted into the fixing device 101 such that the holding elements 105 engage into the guide groove 111. As the rechargeable battery 109 is initially inserted, the rechargeable battery 109 is axially spaced apart from the base module 103. An intermediate space between the base module 103 and the rechargeable battery 109 therefore extends along a longitudinal axis 201, as shown in FIG. 2a.

Proceeding from the arrangement shown in FIG. 2a, the rechargeable battery 109 is displaced further axially, i.e., along the longitudinal axis 201, toward the base module 103. The axial distance between the rechargeable battery 109 and the base module 103 decreases as a result. Due to the displacement, the holding elements 105 closest to the base module 103 form-lockingly engage into the guide groove 111, as shown in FIG. 2b.

The lever 113 has a locking hook 203. In FIG. 2b, the locking hook 203 is aligned with a recess 205 defined in the rechargeable battery 109. The recess 205 is defined in an end face of the rechargeable battery 109, the recess being partially closed by a plate 207. The plate 207 leaves an opening of the recess 205 clear, the opening being aligned orthogonally to the longitudinal axis 201.

If the lever 113 is pivoted from the open position in FIG. 2b towards a closed position, such as to an engagement position between the open and closed positions, the locking hook 203 is received through the opening and engages into the recess 205, as shown in FIG. 2c. As shown in FIGS. 1-2b, 3 and 4, the locking hook 203 has a helical shape. The locking hook 203 has the shape of a portion of a spiral, i.e., of a helix, a central axis, about which the spiral extends, being parallel to the longitudinal axis 201. As a result, the locking hook 203, together with the plate 207, forms a cam mechanism. A further pivoting motion of the lever 113 from the engagement position towards the closed position is converted by the cam into a displacement of the rechargeable battery 109 toward the base module 103. Moving the lever 113 towards the closed position therefore causes the rechargeable battery 109 to be pulled toward the base module 103 by the locking hook 203.

FIG. 2d shows the lever 113 in the closed position. In the closed position, the locking hook 203 is located within the recess 205 and fixes the rechargeable battery 109 relative to the fixing device 101. The lever 113 is fixable in the closed position by a lock 209. The lock 209 also protects the rechargeable battery 109 against unauthorized access.

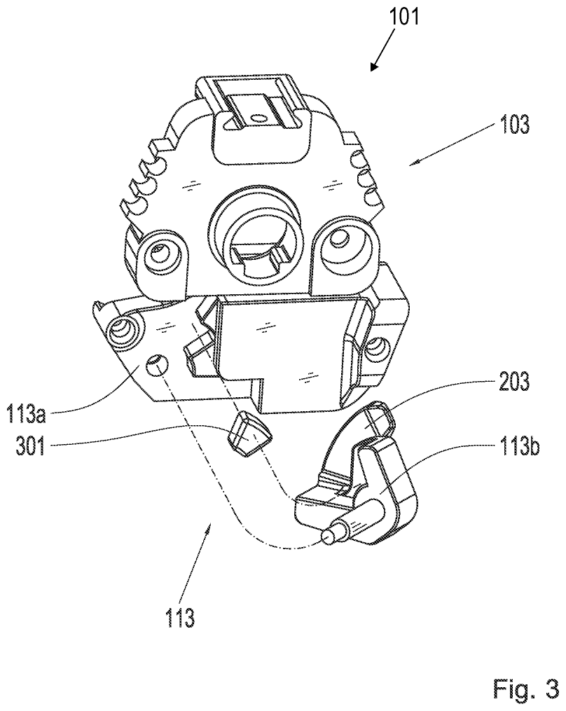

In some instances, the lever 113 has a two-piece design (formed as two separate parts) in order to compensate for tolerance-related dimensional deviations, which helps fix the rechargeable battery 109 in a rattle-free manner. For example, as shown in FIG. 3, the lever 113 consists of a first part 113a and a second part 113b. The lever 113 (not shown) is pivotably mounted to the base module 103 by the first part 113a. The second part 113b is pivotably mounted by the first part 113a to the base module 103. The locking hook 203 is integrally formed on the second part 113b.

The pivotability of the second part 113b in the first part 113a is limited by a spring element 301, such as an elastomer, which is shown in FIG. 3. The elastomer 301 connects the first part 113a and the second part 113b to one another such that a pivoting of the second part 113b in the first part 113a is associated with an elastic deformation of the elastomer 301. In particular, the elastomer 301 is deformed when the locking hook 203 completely engages into the recess 205 and, starting from this position of the lever 113, the first part 113a is pivoted further into its end position. Due to the deformation of the elastomer 301, the elastomer 301 exerts a torque which acts between the first part 113a and the second part 113b and braces the second part 113b against the rechargeable battery 109a, 109b and the plate 207.

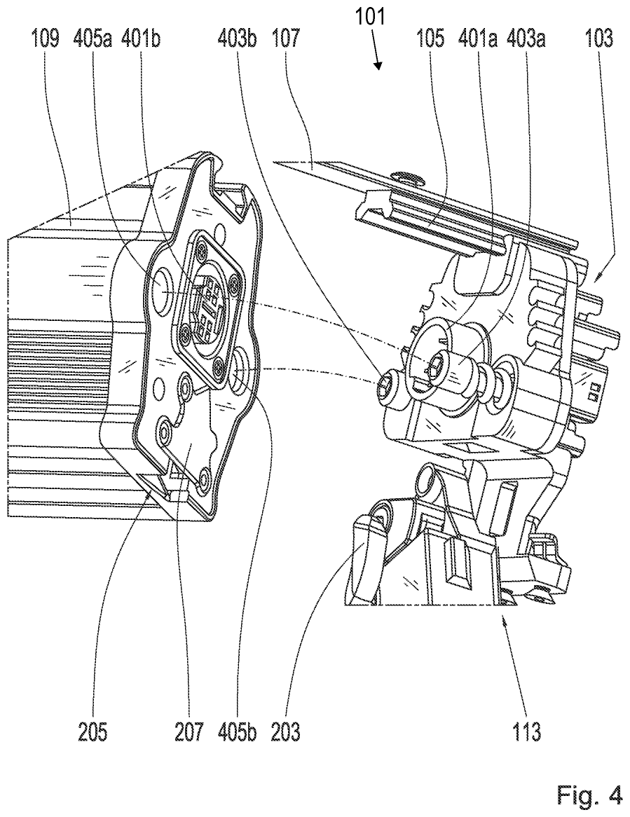

As shown in FIG. 4, the base module 103 has an electrical interface having a plug connector 401a. A plug connector 401b is located on the aforementioned end face of the rechargeable battery 109 having the recess 205. The plug connector 401b is a counterpiece to the plug connector 401a of the base module 103. If the rechargeable battery, as described above, is inserted into the fixing device 101 and fixed by the lever 113, the plug connectors 401a, 401b engage into one another and thus establish an electrical contacting of the rechargeable battery 109a, 109b.

The base module 103 also has two guide pins 403a, 403b. These guide pins 403a, 403b engage into corresponding recesses 405a, 405b in the rechargeable battery 109. The recesses 405a, 405b are located on the same end face of the rechargeable battery 109 as the plug connector 401b. Due to the engagement of the guide pins 403a, 403b into the recesses 405a, 405b, movements of the rechargeable battery 109 orthogonally to the longitudinal axis 201, which damage the plug connectors 401a, 401b, are prevented.

One guide pin 403a is movable and spring-loaded in the longitudinal direction, i.e., along the longitudinal axis 201. Due to the spring force, the guide pin 403a counteracts the gravitational force or weight force of the rechargeable battery 109. This facilitates the insertion and the removal of the rechargeable battery 109.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 frame
101 fixing device
103 base module
105 holder
107 bar
109a rechargeable battery
109b rechargeable battery
111 guide groove
113 lever
113a first part of the lever
113b second part of the lever
201 longitudinal axis
203 locking hook
205 recess
207 plate
209 lock
301 elastomer
401a plug connector
401b plug connector
403a guide pin
403b guide pin
405a recess
405b recess

1.-19. (canceled)

20. An arrangement (101) for fixing an energy storage device (109a, 109b) on a vehicle frame, the arrangement (101) comprising:
a base module (103); and
a lever (113) pivotably mounted to the base module (103), the lever (113) being pivotable relative to the base module (103) into an engagement position and being further pivotable from the engagement position into an end position, the lever (113) being configured to engage an energy storage device (109a, 109b) when in the engagement position, the lever (113) forming part of a cam mechanism such that pivoting of the lever (113) from the engagement position towards the end position is configured to cause displacement of an energy storage device (109a, 109b) towards the base module (103).

21. The arrangement (101) of claim 20, wherein the base module (103) has one or more electrical contacts (401a) configured to contact an energy storage device (109a, 109b).

22. The arrangement (101) of claim 20, wherein the base module (103) has one or more electrical contacts (401a), each of the one or more electrical contacts (401a) being configured to contact a respective electrical contact (401b) of an energy storage device (109a, 109b) as the lever (113) pivots from the engagement position towards the end position.

23. The arrangement (101) of claim 20, wherein the base module (103) has one or more spring-loaded pins (403a) configured to be tensioned against an energy storage device (109a, 109b) as the lever (113) pivots from the engagement position towards the end position.

24. The arrangement (101) of claim 20, further comprising a holder (105) configured to form-lockingly engage with an energy storage device (109a, 109b) at least one of during or as a result of pivoting of the lever (113) from the engagement position towards the end position.

25. The arrangement (101) of claim 24, wherein the holder (105) forms a structural unit with the base module (103).

26. The arrangement (101) of claim 20, wherein a direction of displacement of an energy storage device (109a, 109b) and a longitudinal axis of a portion of a vehicle frame are configured to be aligned parallel to one another.

27. The arrangement (101) of claim 20, wherein an axis about which the lever (113) pivots and a direction of displacement of an energy storage device (109a, 109b) are aligned orthogonally to one another.

28. The arrangement (101) of claim 20, wherein the lever (113) has a guide surface configured to come into contact with a mating surface of an energy storage device (109a, 109b) when the lever (113) is in the engagement position, the guide surface being configured to slide along a mating surface of an energy storage device (109a, 109b) when the lever (113) is pivoted from the engagement position to the end position.

29. The arrangement (101) of claim 28, wherein the guide surface intersects a plane in different axial positions depending on a pivot angle of the lever (113), the plane being configured to be parallel to a direction of displacement of an energy storage device (109a, 109b) and to extend through a mating surface of an energy storage device (109a, 109b).

30. The arrangement (101) of claim 28, wherein the guide surface has a helical shape.

31. The arrangement (101) of claim 28, wherein a portion (203) of the lever (113) is helically shaped, the portion (203) of the lever (113) defining the guide surface.

32. The arrangement (101) of claim 20, wherein the lever (113) has a first part (113a) and a second part (113b), the first part (113a) being pivotably mounted to the base module (130), the second part (113b) being pivotably mounted to the first part (113a), the second part (113b) being configured to engage an energy storage device (109a, 109b) when the lever (113) is pivoted into the engagement position.

33. The arrangement (101) of claim 32, wherein the lever (113) further includes a spring (301) operatively connected to the first part (113a) and the second part (103b), the spring (301) being configured to brace the second part (113b) against an energy storage device (109a, 109b) as the lever (113) pivots from the engagement position to the end position.

34. The arrangement (101) of claim 33, further comprising a fixing mechanism (209) selectively fixing the first part (113a) in a position in which the second part (113b) is configured to brace against an energy storage device (109a, 109b).

35. The arrangement (101) of claim 20, wherein the lever (113) is configured to engage into a recess defined in an energy storage device (109a, 109b) as the lever (113) pivots into the engagement position.

36. The arrangement (101) of claim 35, wherein the recess is configured to be partially covered by a plate (207) mounted on an end face of an energy storage device (109a, 109b).

37. The arrangement (101) of claim 36, wherein the plate (207) forms a mating surface configured to engage with the lever (113).

38. An energy storage device (109a, 109b) configured to be fixed by the arrangement (101) of claim 20.

39. The energy storage device (109a, 109b) of claim 38, comprising a plate (207) mounted on an end face of the energy storage device (109a, 109b) and covering a portion of a recess defined in the energy storage device (109a, 109b).

40. The energy storage device (109a, 109b) of claim 39, wherein the plate (207) forms a mating surface configured to be contacted by the lever (113) when the lever (113) is brought into the engagement position.
